(19) United States
(12) Patent Application Publication
(10) Pub. No.: US 2008/0186005 A1
(43) Pub. Date: Aug. 7, 2008

(54) DYNAMIC VOLTAGE GENERATION DEVICE AND THE USAGE METHOD THEREOF

(75) Inventor: Jian Ru Lin, HsinChu (TW)

Correspondence Address: APEX JURIS, PLLC, 12360 LAKE CITY WAY NORTHEAST, SUITE 410, SEATTLE, WA, 98125, US

(73) Assignee: REALTEK SEMICONDUCTOR CORP., HsinChu (TW)

(21) Appl. No.: 12/025,592

(22) Filed: Feb. 4, 2008

(30) Foreign Application Priority Data
Feb. 6, 2007 (TW) 096104249

(51) Int. Cl. G05F 1/10

(52) U.S. Cl. 323/282

(57) ABSTRACT

The present invention provides a dynamic voltage generation device and the usage method thereof, which is used to output the dynamic voltage and adjust the sampling resistance of the sampling switch. The device comprises a reference switch, ensuring that if the reference switch is matched with the sampling switch, the reference resistance of the reference switch is equal to the sampling resistance. The reference switch obtains the reference resistance based on a fixed voltage and a reference current, wherein the ratio of fixed voltage to reference current is the target resistance. The feedback circuit is coupled with the reference switch to output the dynamic voltage to the reference switch and the sampling switch, and adjusting the dynamic voltage based on the fixed voltage and the reference current, so that the reference resistance is equal to the target resistance.

### CROSS-REFERENCES TO RELATED APPLICATIONS

This non-provisional application claims priority under 35 U.S.C. §119(a) on Patent Application No(s). 096104249 filed in Taiwan, R.O.C. on Feb. 6, 2007, the entire contents of which are hereby incorporated by reference.

### FIELD OF INVENTION

The present invention is a dynamic voltage generation device and method, and particularly a dynamic voltage generation device and method based on processing, voltage and temperature (PVT).

### BACKGROUND OF THE INVENTION

Switch circuit design requires switch resistance to be lower, when faster speed and higher linearity is required, so as to make the switch change smoothly between on and off states, and the switch is regarded as a short circuit when turned on to prevent blockage of the voltage, current or signal flow. The electric circuit design usually employs an MOS (Metal Oxide Semiconductor) to implement the switch. It must therefore bypass appropriately the voltage for the gate voltage of the MOS switch, so as to obtain sufficiently low resistance.

Please refer to FIG. 1A, which is a ramp-up circuit diagram under a hold mode in the prior art. The conventional method, under the hold mode, firstly employs the fixed voltage generator A10 to charge the ramp-up capacitor A20 to the desired voltage V_{fix}. At this time, the sampling switch A30 is in the off state, and the signal is held in sampling capacitor A40.

Please refer to FIG. 1B, which is a ramp-up circuit diagram under a sample mode in the prior art. Next, when converting to the sample mode, it employs the voltage V_{fix} stored in the ramp-up capacitor A20 directly turning on sampling switch A30. Resistance Rₛ of the sampling switch A30 can be derived from textbooks using the following equation:

$${R}_{s} = \frac{1}{{μ}_{n} {C}_{ox} \frac{W}{L} ( {V}_{G S } - {V}_{T I I} )} = \frac{1}{{μ}_{n} {C}_{ox} \frac{W}{L} ( {V}_{fix } - {V}_{TH} )} \qquad ( 1 )$$

In this equation, Rₛ is the resistance of the sampling switch A30, μₙ is the electron mobility, Cₒₓ is the oxide capacitance, W/L is the aspect ratio of the sampling switch A30, V_{GS} is the gate-source voltage of the sampling switch A30, V_{fix} is the voltage provided by the fixed voltage generator A10, and V_{TH} is the threshold voltage.

Generally speaking, μₙ, Cₒₓ and V_{TH} are all influenced by processing and temperature, so these values vary according to different processes. It is possible to determine from equation (1) that, in order to obtain a lower resistance Rₛ, it is necessary to raise V_{fix} appropriately, that is, employing an appropriate overpass voltage to reduce resistance Rₛ. When the voltage of V_{fix} is fixed at one value, it can probably obtain the ideal resistance Rₛ in the best case. But due to the processing variance or yield problem, with the same V_{fix} voltage in the worst case, the obtained resistance Rₛ is not low enough to satisfy the requirement. Therefore, it must choose a sufficiently high V_{fix} to obtain a sufficiently low resistance Rₛ for the sampling switch A30 when during the process for the sampling switch A30 quality loss occurs to the point of worst case. However, device reliability will be reduced if the value of V_{fix} is too high, since this could easily cause damage to the device.

Therefore, the problem to be solved is how to adjust the voltage appropriately to obtain the ideal switch resistance while maintaining device reliability.

### SUMMARY OF THE INVENTION

In view of this problem, the present invention provides a dynamic voltage generation device and method, which can dynamically adjust the voltage applied to a switch based on Process-Voltage-Temperature (PVT).

Research on wafer production processing indicates that the voltage durability of the equipment has two characteristics. The first is that during the process quality loss to the point of worst case produces a thicker oxide layer, so it has a higher voltage durability. The second is that the lower the temperature is, the higher the voltage durability is. For the TSMC 90 nm process, the maximum voltage durability under normal temperature is 1.26V, but when the temperature is reduced to −10° C., the voltage durability is increased to 1.5V.

Based on the above-mentioned characteristics, the present invention provides a dynamic voltage which can dynamically adjust the voltage applied on a switch based on Process-Voltage-Temperature (PVT). The target for adjustment is to make the resistance of the switch compliant with the minimum requirement for the design. When quality is lost to the point of worst case, switch resistance and voltage durability both increase, so the switch appropriately raises the dynamic voltage, to return the switch resistance to the level required by the design. When the quality improves to the point of best case, it can reduce appropriately the dynamic voltage to improve device reliability and extend the lifespan of the IC device. Furthermore, the threshold voltage of the switch is the negative temperature coefficient, which is raised under low temperature. If the dynamic voltage is then held steady, the switch resistance will increase. The characteristic of increased voltage durability under low temperature can therefore be used to raise the dynamic voltage appropriately in order to reduce the switch resistance to the level required by the design. Similarly, under high temperature, reducing the dynamic voltage can improve the device reliability.

The present invention provides a dynamic voltage generation device to output the dynamic voltage and adjust the sampling resistance of the sampling switch. The dynamic voltage generation device includes a reference switch and a feedback circuit.

The reference switch is matched with the sampling switch, so that the reference resistance of the reference switch is equal to the sampling resistance of the sampling switch. Moreover, the reference switch receives the reference current and the fixed voltage, and obtains the target resistance based on the ratio of the fixed voltage to the reference current.

The feedback circuit is coupled with the reference switch, outputs the dynamic voltage to the reference switch and the sampling switch, and adjusts the dynamic voltage based on the fixed voltage and the reference current; and, by adjusting the dynamic voltage, makes the reference resistance equal to the target resistance.

The reference current is inversely proportional to the external resistance, so that the target resistance is proportional to the external resistance, that is, the target resistance is a fixed value associated with the external resistance. Thus it employs dynamic voltage adjustment to make the final sampling resistance refer to the external resistance and the PVT independent fixed value, so as to employ the R tracking mechanism to achieve the effect of dynamically adjusting voltage.

Furthermore, the reference current can be designed to be proportional to the sampling capacitance, so the target resistance is inversely proportional to the sampling capacitance. That is, the target resistance is a fixed value associated with the sampling capacitance. Thus it employs dynamic voltage adjustment to make the PVT independent fixed value equal to the final sampling resistance multiplied by the sampling capacitance, so as to employ the RC tracking mechanism to achieve the effect of dynamic voltage adjustment.

The preferred embodiments and effects related to the present invention will be described in details with the figures as follows.

### BRIEF DESCRIPTION OF THE DRAWINGS

FIG. 1A is a conventional ramp-up circuit diagram under hold mode;

FIG. 1B is a conventional ramp-up circuit diagram under sample mode;

FIG. 2A is a ramp-up circuit diagram under hold mode for the dynamic voltage generation device;

FIG. 2B is a ramp-up circuit diagram under sample mode for the dynamic voltage generation device;

FIG. 3 is a diagram for the dynamic voltage generation device;

FIG. 4 is a flow diagram of the first method for generating the dynamic voltage; and,

FIG. 5 is a flow diagram for the second method for generating the dynamic voltage.

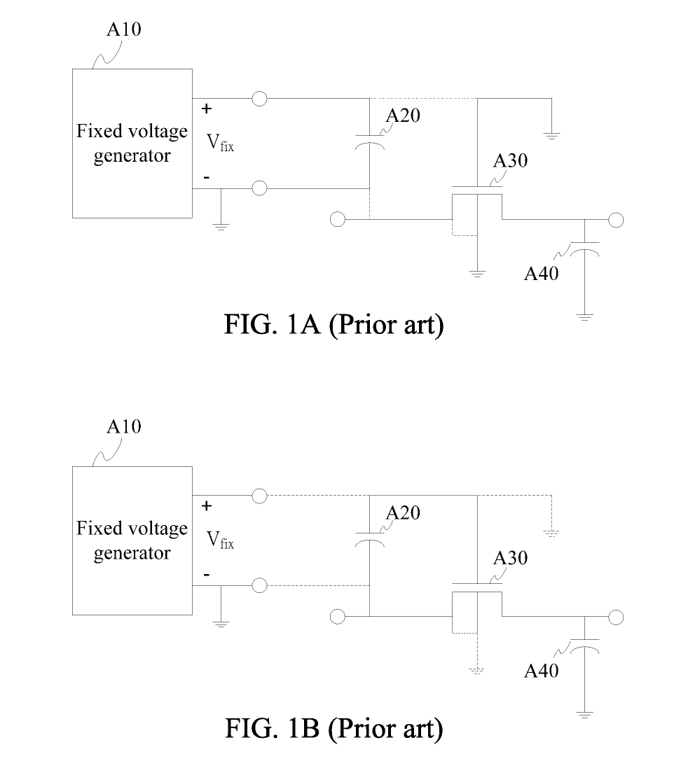

### DESCRIPTION OF THE PREFFERED EMBODIMENTS

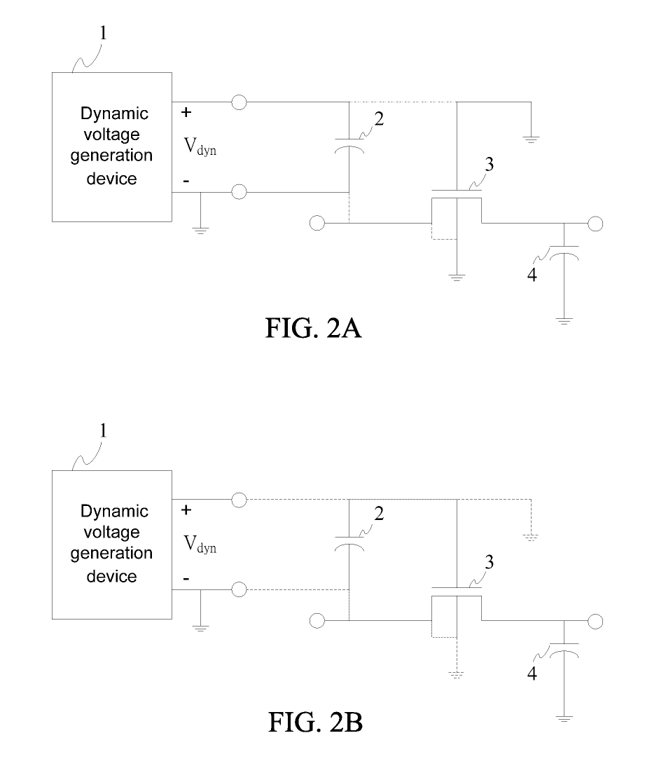

Please refer to FIG. 2A and FIG. 2B, which are respectively the ramp-up circuit diagrams of the dynamic voltage generation device for an embodiment of the present invention under hold mode and sample mode. The dynamic voltage generation device 1 of the present invention is coupled with sampling switch 3 to output the dynamic voltage V_{dyn} to adjust the sampling resistance of sampling switch 3. Under the hold mode in FIG. 2A sampling switch 3 is in the off state, and the signal is kept at sampling capacitor 4. The present invention employs dynamic voltage generation device 1 to charge ramp-up capacitor 2 to a suitable dynamic voltage V_{dyn}.

Under the sample mode in FIG. 2B, ramp-up capacitor 2 will apply the dynamic voltage V_{dyn} outputted by the dynamic voltage generation device 1 on sampling switch 3, and turn on sampling switch 3. Dynamic voltage generation device 1 will adjust voltage V_{dyn} dynamically, based on the Process-Voltage-Temperature of sampling switch 3. Thus the present invention employs dynamic voltage V_{dyn} to turn on sampling switch 3 so the resistance of sampling switch 3 is compliant with the minimum design requirement.

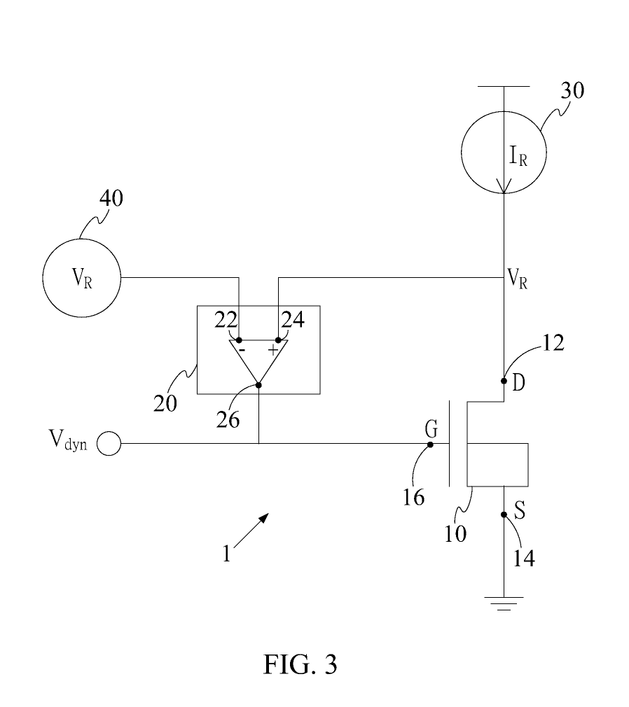

Please refer to FIG. 3, which is a diagram of a dynamic voltage generation device for an embodiment of the present invention. Dynamic voltage generation device 1 includes reference switch 10 and feedback circuit 20. Reference switch 10 is based on sampling switch 3 in FIG. 2A, in which, for convenience, the two switches must be matched with each other. The method of matching the two switches in the process aims to fabricate reference switch 10 and sampling switch 3 together within a very short distance. Because the two switches are matched, all the characteristic parameters of reference switch 10, such as μₙ, Cₒₓ, V_{TH}, are the same as those of sampling switch 3. Another result of the two switches being matched is that when the process is at the point of best case or worst case and the resistance of the switch is affected by the rising and reducing of processing temperature, the influence on the process also changes both the reference resistance and the sampling resistance. Therefore, the reference resistance of reference switch 10 will be substantially equal to the sampling resistance of sampling switch 3.

Reference switch 10 receives reference current 30 and fixed voltage V_{R} 40, and derives the target resistance from the ratio of fixed voltage 40 to reference current 30.

Feedback circuit 20 is coupled with reference switch 10, in which the feedback circuit can detect the reference resistance through reference switch 10. Because Process-Voltage-Temperature equation affects the reference resistance of reference switch 10, the reference resistance is not a fixed value. For this reason feedback circuit 20 is used to detect the reference resistance, so as to obtain the reference resistance of reference switch 10 generated in this process.

Feedback circuit 20 outputs the dynamic voltage V_{dyn} to reference switch 10, and adjusts the dynamic voltage to make the reference resistance equal to the target resistance, where the target resistance is the resistance compliant with the minimum design requirement. According to Ohm's law: Resistance is equal to Voltage divided by Current (R=V/I), the ratio of fixed voltage 40 to reference current 30 becomes the target resistance. Thus by applying reference current 30 and fixed voltage 40 to reference switch 10, the target resistance required by the design is obtained. That is, it can adjust the dynamic voltage based on fixed voltage 40 and reference current 30, so the reference resistance is equal to the target resistance.

Finally, dynamic voltage V_{dyn} is outputted to the sampling switch 3 after adjustment. Because sampling switch 3 is matched with reference switch 10, the adjustment of dynamic voltage V_{dyn} makes the sampling resistance of sampling switch 3 also equal to the target resistance.

As shown in FIG. 3, in the present embodiment, reference switch 10 may be a MOS switch, and includes a drain (D) 12, a source (S) 14, and a gate (G) 16. Moreover, feedback circuit 20 includes a negative input 22, a positive input 24, and an output 26. Negative input 22 is coupled with fixed voltage 40, positive input 24 is coupled with the drain (D) 12 of the reference switch 10, and output 26 outputs dynamic voltage V_{dyn}, and is coupled with gate (G) 16 of reference switch 10. Feedback circuit 20 in the embodiment is presented with an OP amplifier that should not be limited to this form, any similar circuit that provides feedback functions should also be within the scope of this invention.

As shown in FIG. 3, feedback circuit 20 outputs from output 26, passes through reference switch 10, and comes back to positive input 24. The function of feedback circuit 20 not only detects the reference resistance of reference switch 10 as above, but also maintains the voltage of positive input 24 at the same level as fixed voltage V_{R} 40 coupled with negative input 22. Thus, the drain (D) 12 coupled with positive input 24 can also receive fixed voltage V_{R} 40.

Next, we will introduce two examples of adjusting voltage dynamically. The first example is to make reference current 30 inversely proportional to external resistance Rₑₓₜ, so that target resistance Rₜₐᵣ is proportional to external resistance Rₑₓₜ. That is, the target resistance is a fixed value associated with the external resistance. Normally, the chip is provided with a fixed current source generated by a reference external resistance Rₑₓₜ, and external resistance Rₑₓₜ is usually precise, so it can generate a more precise fixed current. Then reference current I_{R} 30 is mirrored to the fixed current source, so that reference current I_{R} 30 becomes

$${I}_{R} = \frac{{V}_{F}}{{R}_{ext}} = \frac{α {V}_{R}}{{R}_{ext}} .$$

In this case, V_{F} is a fixed bandgap voltage. Fixed voltage V_{R} 40 according to the present invention is also a fixed value. The only difference between the two is with regard to the constant ratio (V_{F}=αV_{R}, α is a constant), and V_{F}=V_{R} when constant (α=1) is ignored.

As can be understood from FIG. 3, reference switch 10 produces target resistance Rₜₐᵣ based on reference current I_{R} 30 and fixed voltage V_{R} 40 becoming

$${R}_{tar} = \frac{{V}_{R}}{{I}_{R}} = \frac{{V}_{R}}{( {V}_{R} / {R}_{ext} )} = {R}_{ext} .$$

It can be seen that target resistance Rₜₐᵣ is associated with the precise value of external resistance Rₑₓₜ.

Reference switch 10 is matched with sampling switch 3, so the reference resistance R_{dyn} is equal to the sampling resistance Rₛ. When the reference resistance R_{dyn} is equal to the target resistance Rₜₐᵣ, it is represented as the following equation:

$${R}_{s} = {R}_{dyn} = \frac{1}{{μ}_{n} {C}_{ox} \frac{W}{L} ( {V}_{dyn} - {V}_{TH} )} = {R}_{tar} = {R}_{ext} \qquad ( 2 )$$

As shown in equation (2), to make the reference resistance R_{dyn} equal to the target resistance Rₜₐᵣ, only the adjustment of dynamic voltage V_{dyn} can be employed. Therefore, dynamic voltage generation device 1 automatically adjusts dynamic voltage V_{dyn}, so dynamic voltage V_{dyn} can make reference resistance R_{dyn} equal to target resistance Rₜₐᵣ. Under the sample mode in FIG. 2B, dynamic voltage V_{dyn} after adjustment is transmitted to the sampling switch 3. Because sampling switch 3 is matched with the reference switch 10, dynamic voltage V_{dyn} can also produce sampling resistance Rₛ equal to target resistance Rₜₐᵣ.

From the equation (2), it can be seen that dynamic voltage V_{dyn} generated by the generation device 1 in the embodiment can correlate sampling resistance Rₛ only with external resistance Rₑₓₜ, and become a fixed value independent from PVT.

The second example is to make reference current 30 proportional to sampling capacitance Cs 4, so target resistance Rₜₐᵣ is inversely proportional to sampling capacitance Cs 4. That is, the target resistance is a fixed value associated with the sampling capacitance. Reference current I_{R} 30 is I_{R}=βCₛ=Cₛ. β is a constant and I_{R}=Cₛ when the constant β=1.

As can also be seen from FIG. 3, reference switch 10 produces target resistance Rₜₐᵣ based on reference current I_{R} 30 and fixed voltage V_{R} 40 becoming

$${R}_{tar} = \frac{{V}_{R}}{{I}_{R}} = \frac{{V}_{R}}{{C}_{s}} .$$

Thus target resistance Rₜₐᵣ is associated with sampling capacitance Cₛ 4.

Reference switch 10 is matched with sampling switch 3, so reference resistance R_{dyn} is equal to sampling resistance Rₛ. The following equation represents reference resistance R_{dyn} equal to target resistance Rₜₐᵣ:

$${R}_{s} = {R}_{dyn} = \frac{1}{{μ}_{n} {C}_{ox} \frac{W}{L} ( {V}_{dyn} - {V}_{TH} )} = {R}_{tar} = \frac{{V}_{R}}{{C}_{s}} \qquad ( 3 )$$

Therefore, dynamic voltage generation device 1 automatically adjusts dynamic voltage V_{dyn}, so dynamic voltage V_{dyn} can make reference resistance R_{dyn} equal to target resistance Rₜₐᵣ. Under the sample mode in FIG. 2B, dynamic voltage V_{dyn} after adjustment is transmitted to sampling switch 3,also making sampling resistance Rₛ equal to target resistance Rₜₐᵣ.

Furthermore, because time constant τ is equal to the resistance multiplied by the capacitance, it can derived from the equation (3): τ=RₛCₛ=V_{R}. Because fixed voltage V_{R} is a fixed value, dynamic voltage V_{dyn} generated by dynamic voltage generation device 1 in the example can make time constant τ a fixed value independent from PVT. Thus, the sampling bandwidth also becomes a fixed value independent from PVT.

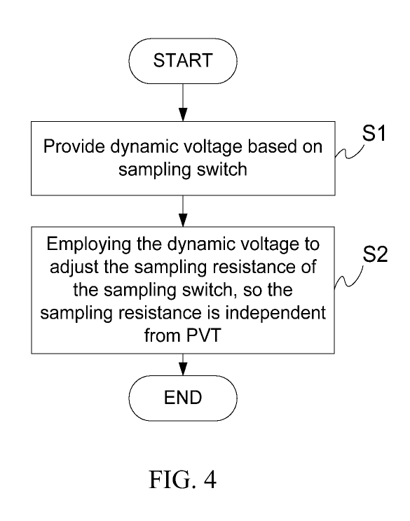

Please refer to FIG. 4, which is a flow chart of a method for turning on the sampling switch. The method includes the following steps:

Step S1: Providing the dynamic voltage based on the sampling switch. The sampling switch is changed based on different processing conditions. It thus makes the sampling resistance of the sampling switch deviate from the original design requirement. Therefore, this step provides different dynamic voltages based on the sampling switch generated by different processes.

Step S2: Employing the dynamic voltage to adjust the sampling resistance of the sampling switch, so the sampling resistance is independent from PVT. The sampling resistance of the sampling switch is associated with the processing parameters, such as μₙ, Cₒₓ, V_{TH}, and the voltage inputted to the sampling switch. When the processing conditions are fixed, the processing parameters are fixed values, so it can only employ the voltage inputted to the sampling switch, i.e. the dynamic voltage referred in the present invention, to adjust the sampling resistance of the sampling switch. Thus, the step outputs different dynamic voltages based on different processes, that is employing the dynamic voltage to adjust the sampling resistance of the sampling switch, and maintaining the sampling resistance as the value required in the design, which does not affect the variance of the sampling resistance due to different processes, so as to make the sampling resistance of the sampling switch independent from PVT.

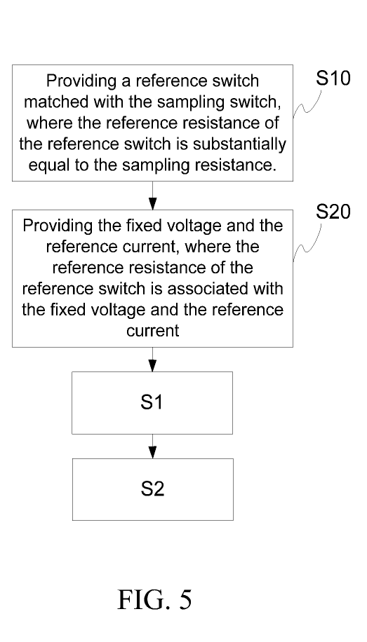

Please refer to FIG. 5. The above-mentioned method for generating the dynamic voltage may include the following additional steps:

Step S10: Providing a reference switch matched with the sampling switch, where the reference resistance of the reference switch is substantially equal to the sampling resistance. The dynamic voltage mentioned in Step S1 and S2 is generated with the feedback mechanism based on the reference resistance.

Step S20: Providing the fixed voltage and the reference current, where the reference resistance of the reference switch is associated with the fixed voltage and the reference current. The reference current may be inversely proportional to the external resistance, or proportional to the sampling capacitance.

According to Ohm's law: Resistance is equal to Voltage divided by Current (R=V/I), the ratio of the fixed voltage to the reference current is a target resistance. Thus the reference switch can obtain the target resistance required by the design based on the fixed voltage and the reference current.

As mentioned previously, when the reference current is inversely proportional to the external resistance the target resistance is proportional to the external resistance, that is, the target resistance is a fixed value associated with the external resistance. Similarly, when the reference current is proportional to the sampling capacitance the target resistance is inversely proportional to the sampling capacitance, that is, the target resistance is a fixed value associated with the sampling capacitance.

The feedback mechanism mentioned in Step S10 can be achieved with an OP amplifier associated with the reference switch. In the present embodiment the reference switch may be a MOS switch, the drain of which receives the reference current and the fixed voltage provided in Step S20, and the source is grounded. The negative input of the OP amplifier is coupled with the fixed voltage, and with the positive input coupled with the drain of the MOS switch, and the output of the OP amplifier is coupled with the gate of the MOS switch.

It is well known from textbooks that the resistance of the reference switch is associated with multiple parameters, and these parameters vary according to the influence of PVT. After completing production of the reference switch, it can only adjust the dynamic voltage applied on the reference switch to adjust the reference resistance, so the reference resistance is equal to the target resistance.

Because the sampling switch is matched with the reference switch, the two switches have the same parameters. Thus, the dynamic voltage after adjustment is outputted to the sampling switch, and the sampling resistance of the sampling switch can also be equal to the target resistance.

Therefore, the present invention can dynamically adjust the voltage provided to the switch based on PVT, and further obtain the switch resistance required in the design independent from PVT.

The technical contents of the present invention have been disclosed with preferred embodiments as above. However, the disclosed embodiments are not used to limit the present invention. Those with appropriate knowledge and proficiency could make slight changes and modification without departing from the spirit of the present invention, and all such the changes and modification made thereto are covered by the scope of the present invention. The protection scope for the present invention should be defined according to the attached claims.

What is claimed is:

1. A dynamic voltage generation device outputting a dynamic voltage to turn on a sampling switch, comprising:
a reference switch, fabricated according to the sampling switch; and,
a feedback circuit, generating a dynamic voltage according to the reference switch;
wherein a sampling resistance for the sampling switch is changed according to the dynamic voltage.

2. The device according to claim 1, wherein the reference switch matches the sampling switch.

3. The device according to claim 1, wherein the sampling resistance is independent from processing, voltage and temperature (PVT).

4. The device according to claim 1, wherein a reference resistance of the reference switch is substantially equal to the sampling resistance.

5. The device according to claim 1, wherein the reference switch generates the reference resistance based on a fixed voltage and a reference current.

6. The device according to claim 5, wherein the ratio of the fixed voltage to the reference current is a target resistance.

7. The device according to claim 6, wherein the reference current is inversely proportional to an external resistance, so that the target resistance is proportional to the external resistance.

8. The device according to claim 6, wherein the reference current is proportional to a sampling capacitance, so that the target resistance is inversely proportional to the sampling capacitance.

9. The device according to claim 5, wherein the reference switch is a MOS switch, the drain of which is used to receive the reference current and the fixed voltage.

10. The device according to claim 9, wherein the feedback circuit comprises an OP amplifier with the negative input coupled with the fixed voltage and the positive input coupled with the drain of the MOS switch, and the output coupled with the gate of the MOS switch, and outputs the dynamic voltage at the output.

11. A method for turning on a sampling switch, which comprises the steps of:
providing a dynamic voltage based on the sampling switch; and,
employing the dynamic voltage to adjust a sampling resistance of the sampling switch, so the sampling resistance is independent from processing, voltage and temperature (PVT).

12. The method according to claim 11, further comprising the step of:
providing a reference switch matched with the sampling switch, in which a reference resistance of the reference switch is substantially equal to the sampling resistance.

13. The method according to claim 12, further comprising the step of:
providing a fixed voltage and a reference current, in which the reference switch generates the reference resistance based on the fixed voltage and the reference current.

14. The method according to claim 13, wherein the ratio of the fixed voltage to the reference current is a target resistance.

15. The method according to claim 14, wherein the reference current is inversely proportional to an external resistance, so the target resistance is proportional to the external resistance.

16. The method according to claim 14, wherein the reference current is proportional to a sampling capacitance, so the target resistance is inversely proportional to the sampling capacitance.

17. The method according to claim 13, wherein the reference switch is a MOS switch, the drain of which is used to receive the reference current and the fixed voltage.

18. The method according to claim 12, wherein the dynamic voltage is generated based on the reference resistance with a feedback mechanism.
